(19) United States
(12) Patent Application Publication
(10) Pub. No.: US 2020/0048577 A1
(43) Pub. Date: Feb. 13, 2020

(54) Lubricant for Low Global Warming Potential Refrigerant Systems

(71) Applicant: The Lubrizol Corporation, Wickliffe, OH (US)

(72) Inventors: Mark R. Baker, Midland, MI (US); Michael G. Foster, Midland, MI (US); Joseph A. Karnaz, The Woodlands, TX (US); Neil D. Turner, Midland, MI (US)

(21) Appl. No.: 16/340,437

(22) PCT Filed: Sep. 28, 2017
(86) PCT No.: PCT/US2017/053876

§ 371 Date: Apr. 9, 2019

Related U.S. Application Data
(60) Provisional application No. 62/406,197, filed on Oct. 10, 2016.

(51) Int. Cl. C10M 171/00; C09K 5/04; C10M 105/38; C10M 111/02; C10M 169/04

(52) U.S. Cl. CPC C10M 171/008; C09K 5/045; C10M 105/38; C10M 111/02; C10M 169/04; C10N 2220/302; C09K 2205/126; C10M 2203/065; C10M 2205/0285; C10M 2207/2835; C10N 2220/027; C09K 2205/122

(57) ABSTRACT

The disclosed technology relates to a working fluid for a low global warming potential (GWP) refrigeration system that includes a compressor, where the working fluid includes a polyolester oil, an alkylbenzene oil, and a low GWP refrigerant, and where the ester based lubricant comprises dipentaerythritol esterified with a mixture of carboxylic acids, wherein the mixture of carboxylic acids comprises at least one linear carboxylic acid having 8 to 10 carbon atoms. The disclosed technology provides commercially useful low GWP working fluids (commercially useful working fluids based on low GWP refrigerants) that do not have the solubility and/or miscibility problems commonly seen in low GWP fluids, including high viscosity fluids and applications.

The disclosed technology relates to a working fluid for a low global warming potential (GWP) refrigeration system that includes a compressor, where the working fluid includes a polyolester oil, alkylbenzene, and a low GWP refrigerant, wherein the polyolester oil comprises at least one linear carboxylic acid having 8 to 10 carbon atoms. The disclosed technology provides commercially useful low GWP working fluids (commercially useful working fluids based on low GWP refrigerants) that provide desired solubility, miscibility, and viscosity, for use in low GWP fluids.

### BACKGROUND OF THE INVENTION

Mechanical refrigeration systems, and related heat transfer devices such as heat pumps and air conditioners, using refrigerant fluids are well known in the art for industrial, commercial and domestic uses. Fluorocarbon based fluids have found widespread use in many residential, commercial and industrial applications, including as the working fluid in systems such as air conditioning, heat pump and refrigeration systems. Because of certain suspected environmental problems, including the relatively high global warming potentials associated with the use of some of the compositions that have heretofore been used in these applications, it has become increasingly desirable to use fluids having low or even zero ozone depletion potential, such as hydrofluorocarbons (“HFCs”). Furthermore, a number of governments have signed the Kyoto Protocol to protect the global environment setting forth a reduction of carbon dioxide emissions (global warming). Thus, there is a need for a low- or non-flammable, non-toxic alternative to replace certain high global warming potential HFCs.

There has thus been an increasing need for new fluorocarbon and hydrofluorocarbon compounds and compositions that are attractive alternatives to the compositions heretofore used in these and other applications. With regard to efficiency in use, it is important to note that a loss in refrigerant thermodynamic performance or energy efficiency may have secondary environmental impacts through increased fossil fuel usage arising from an increased demand for electrical energy. Furthermore, it is generally considered desirable for HFC refrigerant substitutes to be effective without major engineering changes to conventional vapor compression technology currently used with HFC refrigerants.

As the industry has attempted to meet this need, and to provide commercially useful low global warming potential working fluids, it has been found that low global warming potential (GWP) refrigerants have different solubility and miscibility characteristics than traditional HFC refrigerants. As such, many solubility and miscibility problems occur when conventional lubricants that are typically used with HFC refrigerants are now used with low GWP refrigerants. Typically, conventional lubricants, including conventional polyolester (POE) based lubricants, are not believed to be able to provide the miscibility/solubility properties needed to enable these new refrigerant chemistries, to perform satisfactorily and meet the system performance requirements set forth by the hardware manufacturers. Thus the working fluids based on these low GWP refrigerants are difficult to use and do not perform as well as required, especially when a higher viscosity working fluid is needed since miscibility problems become more pronounced.

There is an ongoing need for commercially useful low GWP working fluids (commercially useful working fluids based on low GWP refrigerants) that do not have the solubility and/or miscibility problems commonly seen in such fluids, and the need is particularly great for higher viscosities fluids and applications.

### SUMMARY OF THE INVENTION

The disclosed technology provides a working fluid for a low global warming potential (GWP) refrigeration system that includes a compressor, where the working fluid comprises (a) a lubricating oil component comprising (i) a polyolester oil, wherein the polyolester oil comprises dipentaerythritol esterified with a mixture of carboxylic acids, wherein the mixture of carboxylic acids comprises at least one linear carboxylic acid having 8 to 10 carbon atoms and (ii) alkylbenzene, and (b) a low GWP refrigerant. In one embodiment of the technology, the low GWP refrigerant comprises hydrofluoroolefin-1336mzzZ/trans-1,2-dichloroethylene.

The disclosed technology provides the working fluid described herein where the polyolester oil comprises 10 mol % to 20 mol % dipentareythritol, 0 mol % to 10 mol % of a linear carboxylic acid having 5 carbon atoms, 3 mol % by weight to 10 mol % of a linear carboxylic acid having 7 carbon atoms, 10 mol % to 20 mol % of a linear carboxylic acid having 8 carbon atoms, 40 mol % to 70 mol % of a branched carboxylic acid having 9 carbon atoms, and 5 mol % to 12 mol % of a linear carboxylic acid having 10 carbon atoms.

In another embodiment, the disclosed technology provides a working fluid comprising (a) a lubricating oil component comprising (i) a polyolester oil, wherein the polyolester oil comprises dipentaerythritol esterified with a mixture of carboxylic acids, wherein the mixture of carboxylic acids is substantially free of C5 carboxylic acids, for example, linear C5 carboxylic acids and (ii) alkylbenzene, and (b) a low GWP refrigerant. The low GWP refrigerant comprises hydrofluoroolefin-1336mzzZ/trans-1,2-dichloroethylene.

The disclosed technology provides the described working fluid where the lubricating oil component comprises 75% by weight to 95% by weight polyolester oil and 5% by weight to 25% by weight alkylbenzene.

The disclosed technology also provides a lubricating composition for use in connection with a low GWP refrigerant, wherein the lubricating composition comprises a mixture of a polyolester oil and alkylbenzene. In one embodiment, the polyolester oil comprises 10 mol % to 20 mol % dipentareythritol, 0 mol % to 10 mol % of a linear carboxylic acid having 5 carbon atoms, 3 mol % by weight to 10 mol % of a linear carboxylic acid having 7 carbon atoms, 10 mol % to 20 mol % of a linear carboxylic acid having 8 carbon atoms, 40 mol % to 70 mol % of a branched carboxylic acid having 9 carbon atoms, and 5 mol % to 12 mol % of a linear carboxylic acid having 10 carbon atoms.

The disclosed technology provides the described working fluid where the low GWP refrigerant comprises hydrofluoroolefin-1336mzzZ/trans-1,2-dichloroethylene.

The disclosed technology provides the described working fluid where the described low GWP refrigerant has a GWP value (as calculated per the Intergovernmental Panel on Climate Change's 2001 Third Assessment Report) of not greater than about 1000. The disclosed technology also provides the described working fluid where the described low GWP refrigerant has a GWP value of less than 1000, less than 800, or even less than 650. In some embodiments, this GWP value is with regards to the overall working fluid. In other embodiments, this GWP value is with regards to the refrigerant present in the working fluid, where the resulting working fluid may be referred to as a low GWP working fluid.

The disclosed technology further provides a refrigeration system that includes a compressor and a working fluid, where the working fluid includes a lubricating oil component comprising (a) a polyolester oil, wherein the polyolester oil comprises dipentaerythritol esterified with a mixture of carboxylic acids, wherein the mixture of carboxylic acids comprise at least one linear carboxylic acid having 8 to 10 carbon atoms, and (ii) alkylbenzene, and (B) a low GWP refrigerant, wherein the low GWP refrigerant comprises hydrofluoroolefin-1336mzzZ/trans-1,2-dichloroethylene.

In another embodiment, the disclosed technology provides a refrigeration system that includes a compressor and a working fluid, where the working fluid comprises (a) a lubricating oil component comprising (i) a polyolester oil, wherein the polyolester oil comprises dipentaerythritol esterified with a mixture of carboxylic acids, wherein the mixture of carboxylic acids is substantially free of C5 carboxylic acids, for example, linear C5 carboxylic acids and (ii) alkylbenzene, and (b) a low GWP refrigerant. The low GWP refrigerant comprises hydrofluoroolefin-1336mzzZ/trans-1,2-dichloroethylene

The described refrigeration system may utilize any of the working fluids described herein, including but not limited to the described working fluid where the low GWP refrigerant has a GWP value of less than 1000, less than 800, or even less than 650. In some embodiments, this GWP value is with regards to the overall working fluid. In other embodiments, this GWP value is with regards to the refrigerant present in the working fluid, where the resulting working fluid may be referred to as a low GWP working fluid.

The described refrigeration system may utilize any of the working fluids described herein, including but not limited to the described working fluid where the working fluid further includes a non-low GWP refrigerant blended with the said low GWP refrigerant, resulting in a working fluid that may still be referred to as a low GWP working fluid.

The disclosed technology further provides a method of operating a refrigeration system that utilizes a low GWP refrigerant, said method including the step of: (I) supplying to said refrigeration system a working fluid comprising (a) a lubricating oil component comprising (i) a polyolester oil, wherein the polyolester oil comprises dipentaerythritol esterified with a mixture of carboxylic acids, wherein the mixture of carboxylic acids comprise at least one linear carboxylic acid having 8 to 10 carbon atoms and (ii) alkylbenzene, and (b) a low GWP refrigerant, comprising hydrofluoroolefin-1336mzzZ/trans-1,2-dichloroethylene.

In another embodiment, the disclosed technology provides a method of operating a refrigeration system that utilizes a low GWP refrigerant, said method including the step of (I) supplying to said refrigeration system a working fluid comprising (a) a lubricating oil component comprising (i) a polyolester oil, wherein the polyolester oil comprises dipentaerythritol esterified with a mixture of carboxylic acids, wherein the mixture of carboxylic acids is substantially free of C5 carboxylic acids, for example, linear C5 carboxylic acids and (ii) alkylbenzene, and (b) a low

GWP refrigerant, comprising hydrofluoroolefin-1336mzzZ/trans-1,2-dichloroethylene

The disclosed technology further provides the use of a lubricating oil component comprising (i) a polyolester oil, wherein the polyolester oil comprises dipentaerythritol esterified with a mixture of carboxylic acids, wherein the mixture of carboxylic acids comprise at least one linear carboxylic acid having 8 to 10 carbon atoms or is substantially free of C5 carboxylic acids and (ii) alkylbenzene in combination with a low GWP refrigerant comprising hydrofluoroolefin-1336mzzZ/trans-1,2-dichloroethylene.

### DETAILED DESCRIPTION OF THE INVENTION

Various preferred features and embodiments will be described below by way of non-limiting illustration.

The disclosed technology further provides a working fluid for a low global warming potential (GWP) refrigeration system that includes a compressor. The working fluid includes a lubricating component comprising a polyolester oil and alkylbenzene. The working fluid comprises a low GWP refrigerant, in particular, hydrofluoroolefin-1336mzzZ/trans-1,2-dichloroethylene.

The polyolester oil comprises the reaction product of a polyol with linear an/or branched carboxylic acids.

In some embodiments, the polyol used in the preparation of the ester includes neopentyl glycol, glycerol, trimethylol propane, pentaerythritol, dipentaerythritol, tripentaerythritol, or any combination thereof. In some embodiments, the polyol used in the preparation of the ester includes neopentyl glycol, pentaerythritol, dipentaerythritol, or any combination thereof. In some embodiments, the polyol used in the preparation of the ester includes neopentyl glycol. In some embodiments, the polyol used in the preparation of the ester includes pentaerythritol. In some embodiments, the polyol used in the preparation of the ester includes dipentaerythritol.

The polyol is esterified using one or more linear or branched carboxylic acids. The linear or branched carboxylic acids may comprise 2 to 12 carbon atoms. In one embodiment, the polyolester oil comprises a mixture of linear and branched carboxylic acids. In one embodiment, the polyolester oil comprises dipentareythritol esterified by one or more of a linear carboxylic acid having 5 carbon atoms, a linear carboxylic acid having 7 carbon atoms, a linear carboxylic acid having 8 carbon atoms, a branched carboxylic acid having 9 carbon atoms, a linear carboxylic acid having 10 carbon atoms. In one embodiment, the polyolester oil comprises 10 mol % to 20 mol %, or even 12 mol % to 18 mol %, dipentareythritol, 0 mol % to 10 mol %, or even 0 mol % to 3 mol %, of a linear carboxylic acid having 5 carbon atoms, 3 mol % by weight to 10 mol %, or even 3 mol % to 7 mol %, of a linear carboxylic acid having 7 carbon atoms, 10 mol % to 20 mol %, or even 12 mol % to 18 mol %, of a linear carboxylic acid having 8 carbon atoms, 40 mol % to 70 mol %, or even 60 mol % to 60 mol %, of a branched carboxylic acid having 9 carbon atoms, and 5 mol % to 12 mol %, or even 8 mol % to 12 mol %, of a linear carboxylic acid having 10 carbon atoms. In one embodiment, the polyolester oil comprises In one embodiment, the polyolester oil comprises 10 mol % to 20 mol %, or even 12 mol % to 18 mol %, dipentareythritol, 3 mol % by weight to 10 mol %, or even 3 mol % to 7 mol %, of a linear carboxylic acid having 7 carbon atoms, 10 mol % to 20 mol %, or even 12 mol % to 18 mol %, of a linear carboxylic acid having 8 carbon atoms, 40 mol % to 70 mol %, or even 60 mol % to 60 mol %, of a branched carboxylic acid having 9 carbon atoms, and 5 mol % to 12 mol %, or even 8 mol % to 12 mol %, of a linear carboxylic acid having 10 carbon atoms, wherein the polyolester oil is substantially free of C5 carboxylic acid, such as linear C5 carboxylic acid.

In another useful embodiment, the polyolester oil consists essentially of dipentareythritol esterified by a linear carboxylic acid having 7 carbon atoms, a linear carboxylic acid having 8 carbon atoms, a branched carboxylic acid having 9 carbon atoms, and a linear carboxylic acid having 10 carbon atoms.

The lubricating oil component also comprises an alkylbenzene. The alkylbenzene useful in the disclosed technology includes an alkyl chain having 6 to 24, or even 6 to 36, carbon atoms, which may be mono or disubstituted and may be linear or branched. In one embodiment, the alkylbenzene has a linear alkyl chain having 6 to 24 or even 6 to 12 carbon atoms. In another embodiment, the alkylbenzene has a branched alkyl chain having 12 to 36 carbon atoms.

In one embodiment, the viscosity of the polyolester oil prior to blending into the working fluid (“neat” viscosity) is 150 cSt to 180 cSt as measured by ASTM D445 at 40° C. In one embodiment, the viscosity of the alkylbenzene prior to blending into the working fluid (“neat” viscosity) is 3 cSt to 100 cSt as measured by ASTM D445 at 100° C.

The lubricating oil component in the disclosed working fluid may comprise 75% by weight to 95% by weight, or 80% by weight to 90% by weight, or even 80% by weight to 85% by weight polyolester oil and 5% by weight to 25%, or 10% by weight to 20% by weight, or even 15% by weight to 20% by weight alkylbenzene.

It is noted that a key feature of the disclosed technology is the ability to provide a high viscosity low GWP working fluid that has good miscibility and solubility at desired viscosities.

As noted by above, by “low GWP”, it is meant the working fluid has a GWP value (as calculated per the Intergovernmental Panel on Climate Change's 2001 Third Assessment Report) of not greater than about 1000, or a value that is less than 1000, less than 800, or even less than 650. In some embodiments, this GWP value is with regards to the overall working fluid. In other embodiments, this GWP value is with regards to the refrigerant present in the working fluid, where the resulting working fluid may be referred to as a low GWP working fluid.

By “good miscibility” it is meant that the refrigerant and lubricant are miscible, at least at the conditions the described working fluid will see during the operation of a refrigeration system. In some embodiments, good miscibility can mean that the working fluid (and/or the combination of refrigerant and lubricant) does not show any signs of poor miscibility other than visual haziness at temperatures as low as 0 C, or even −5 C, or even in some embodiments as low as −20 C or lower.

The working fluids of the invention also include one or more refrigerants. At least one of the refrigerants is a low GWP refrigerant. In some embodiments, all of the refrigerants present in the working fluid are low GWP refrigerants. In the working fluids described herein, the refrigerant comprises or consists essentially of R-514A, which is hydrofluorool efi n-1336mzzZ/trans -1,2-dichloroethylene.

It is noted that the described working fluids may in some embodiments also include one or more other low GWP refrigerants or non-low GWP refrigerant, blended with the low GWP refrigerant, resulting in a low GWP working fluid.

The described working fluids, at least in regards to how they would be found in the evaporator of the refrigeration system in which they are used, may be from about 5 to about 50 percent by weight lubricant, and from 95 to 50 percent by weight refrigerant. In some embodiments, the working fluid is from 10 to 40 percent by weight lubricant, or even from 10 to 30 or 10 to 20 percent by weight lubricant.

The described working fluids, at least in regards to how they would be found in the sump of the refrigeration system in which they are used, may be from about 1 to 50, or even 5 to 50 percent by weight refrigerant, and from 99 to 50 or even 95 to 50 percent by weight lubricant. In some embodiments, the working fluid is from 90 to 60 or even 95 to 60 percent by weight lubricant, or even from 90 to 70 or even 95 to 70, or 90 to 80 or even 95 to 80 percent by weight lubricant.

The described working fluids may include other components for the purpose of enhancing or providing certain functionality to the composition, or in some cases to reduce the cost of the composition.

The described working fluids may further include one or more performance additives. Suitable examples of performance additives include antioxidants, metal passivators and/or deactivators, corrosion inhibitors, antifoams, antiwear inhibitors, corrosion inhibitors, pour point depressants, viscosity improvers, tackifiers, metal deactivators, extreme pressure additives, friction modifiers, lubricity additives, foam inhibitors, emulsifiers, demulsifiers, acid catchers, or mixtures thereof.

In some embodiments, the compositions of the present invention include an antioxidant. In some embodiments, the compositions of the present invention include a metal passivator, wherein the metal passivator may include a corrosion inhibitor and/or a metal deactivator. In some embodiments, the compositions of the present invention include a corrosion inhibitor. In still other embodiments, the compositions of the present invention include a combination of a metal deactivator and a corrosion inhibitor. In still further embodiments, the compositions of the present invention include the combination of an antioxidant, a metal deactivator and a corrosion inhibitor. In any of these embodiments, the compositions may further include one or more additional performance additives.

The antioxidants suitable for use in the present invention are not overly limited. Suitable antioxidants include butylated hydroxytoluene (BHT), butylatedhydroxyanisole (BHA), phenyl-a-naphthylamine (PANA), octylated/butylated diphenyl amine, high molecular weight phenolic antioxidants, hindered bis-phenolic antioxidant, di-alpha-tocopherol, di-tertiary butyl phenol. Other useful antioxidants are described in U.S. Pat. No. 6,534,454 incorporated herein by reference

In some embodiments, the antioxidant includes one or more of:
(i) Hexamethylene bis(3,5-di-tert-butyl-4-hydroxyhydrocinnamate), CAS registration number 35074-77-2, available commercially from BASF;
(ii) N-phenylbenzenamine, reaction products with 2,4,4-trimethylpentene, CAS registration number 68411-46-1, available commercially from BASF;
(iii) Phenyl-a-and/or phenyl-b-naphthylamine, for example N-phenyl-ar-(1,1,3,3-tetramethylbutyl)-1-naphthalenamine, available commercially from BASF;
(iv) Tetraki s [methyl ene(3,5-di-tert-butyl-4-hydroxyhydrocinnam ate)] methane, CAS registration number 6683-19-8;
(v) Thiodiethylenebis (3,5-di-tent-butyl-4-hydroxyhydrocinnamate), CAS registration number 41484-35-9, which is also listed as thiodiethylenebis (3,5-di-tert-butyl-4-hydroxy-hydro-cinnamate) in 21 C.F.R. §178.3570;
(vi) Butylated hydroxytoluene (BHT);

(vii) Butylated hydroxyanisole (BHA),
(viii) Bis(4-(1,1,3,3-tetramethylbutyl)phenyl)amine, available commercially from BASF; and
(ix) Benzenepropanoic acid, 3,5-bis(1,1-dimethylethyl)-4-hydroxy-, thiodi-2,1-ethanediyl ester, available commercially from BASF.

The antioxidants may be present in the composition from 0.01% to 6.0% or from 0.02%, to 1%. The additive may be present in the composition at 1%, 0.5%, or less. These various ranges are typically applied to all of the antioxidants present in the overall composition. However, in some embodiments, these ranges may also be applied to individual antioxidants.

The metal passivators suitable for use in the present invention are not overly limited and may include both metal deactivators and corrosion inhibitors.

Suitable metal deactivators include triazoles or substituted triazoles. For example, tolyltriazole or tolutriazole may be utilized in the present invention. Suitable examples of metal deactivator include one or more of:
(i) One or more tolu-triazoles, for example N,N-Bis(2-ethylhexyl)-ar-methyl-1H-benzotriazole-1-methanamine, CAS registration number 94270-86-70, sold commercially by BASF under the trade name Irgamet 39;
(ii) One or more fatty acids derived from animal and/or vegetable sources, and/or the hydrogenated forms of such fatty acids, for example Neo-Fat™ which is commercially available from Akzo Novel Chemicals, Ltd.

Suitable corrosion inhibitors include one or more of:
(i) N-Methyl-N-(1-oxo-9-octadecenyl)glycine, CAS registration number 110-25-8;
(ii) Phosphoric acid, mono- and diisooctyl esters, reacted with tent-alkyl and (C12-C14) primary amines, CAS registration number 68187-67-7;
(iii) Dodecanoic Acid;
(iv) Triphenyl phosphorothionate, CAS registration number 597-82-0; and
(v) Phosphoric acid, mono- and dihexyl esters, compounds with tetramethylnonylamines and C11-14 alkylamines.

In one embodiment, the metal passivator is comprised of a corrosion additive and a metal deactivator. One useful additive is the N-acyl derivative of sarcosine, such as an N-acyl derivative of sarcosine. One example is N-methyl-N-(1-oxo-9-octadecenyl) glycine. This derivative is available from BASF under the trade name SARKOSYL™ 0. Another additive is an imidazoline such as Amine O™ commercially available from Ciba-Geigy.

The metal passivators may be present in the composition from 0.01% to 6.0% or from 0.02%, to 0.1%. The additive may be present in the composition at 0.05% or less. These various ranges are typically applied to all of the metal passivator additives present in the overall composition. However, in some embodiments, these ranges may also be applied to individual corrosion inhibitors and/or metal deactivators. The ranges above may also be applied to the combined total of all corrosion inhibitors, metal deactivators and antioxidants present in the overall composition.

The compositions described herein may also include one or more additional performance additives. Suitable additives include antiwear inhibitors, rust/corrosion inhibitors and/or metal deactivators (other than those described above), pour point depressants, viscosity improvers, tackifiers, extreme pressure (EP) additives, friction modifiers, foam inhibitors, emulsifiers, and demulsifiers.

To prevent wear on the metal surface, the present invention may utilize an anti-wear inhibitor/EP additive and friction modifier. Anti-wear inhibitors, EP additives, and friction modifiers are available off the shelf from a variety of vendors and manufacturers. Some of these additives can perform more than one task and any may be utilized in the present invention. One product that can provide anti-wear, EP, reduced friction and corrosion inhibition is phosphorus amine salt such as Irgalube 349, which is commercially available from BASF. Another anti-wear/EP inhibitor/friction modifier is a phosphorus compound such as is triphenyl phosphothionate (TPPT), which is commercially available from BASF under the trade name Irgalube TPPT. Another anti-wear/EP inhibitor/friction modifier is a phosphorus compound such as is tricresyl phosphate (TCP), which is commercially available from Chemtura under the trade name Kronitex TCP. Another anti-wear/EP inhibitor/friction modifier is a phosphorus compound such as is t-butylphenyl phosphate, which is commercially available from ICL Industrial Products under the trade name Syn-O-Ad 8478. The anti-wear inhibitors, EP, and friction modifiers are typically about 0.1% to about 4% of the composition and may be used separately or in combination.

In some embodiments, the composition further includes an additive from the group comprising: viscosity modifiers-including, but not limited to, ethylene vinyl acetate, polybutenes, polyisobutylenes, polymethacrylates, olefin copolymers, esters of styrene maleic anhydride copolymers, hydrogenated styrene-diene copolymers, hydrogenated radial polyisoprene, alkylated polystyrene, fumed silicas, and complex esters; and tackifiers like natural rubber solubilized in oils.

The addition of a viscosity modifier, thickener, and/or tackifier provides adhesiveness and improves the viscosity and viscosity index of the lubricant. Some applications and environmental conditions may require an additional tacky surface film that protects equipment from corrosion and wear. In this embodiment, the viscosity modifier, thickener/tackifier is about 1 to about 20 weight percent of the lubricant. However, the viscosity modifier, thickener/tackifier can be from about 0.5 to about 30 weight percent. An example of a material that can be used in this invention is Functional V-584 a Natural Rubber viscosity modifier/tackifier, which is available from Functional Products, Inc., Macedonia, Ohio. Another example is a complex ester CG 5000 that is also a multifunctional product, viscosity modifier, pour point depressant, and friction modifier from Inolex Chemical Co. Philadelphia, Pa.

The disclosed technology also provides a refrigeration system, where the refrigeration system includes a compressor and a working fluid, where the working fluid includes (a) a lubricating oil component comprising (i) a polyolester oil, wherein the polyolester oil comprises dipentaerythritol esterified with a mixture of carboxylic acids, wherein the mixture of carboxylic acids comprise at least one linear carboxylic acid having 8 to 10 carbon atoms and (ii) alkylbenzene, and (b) a low GWP refrigerant, wherein the low GWP refrigerant comprises hydrofluoroolefin-1336mzzZ/trans-1,2-dichloroethylene. In some embodiments, the working fluid may be free of or substantially free of C5 carboxylic acids, such as linear carboxylic acids. Any of the working fluids or components of working fluids described herein may be used in the described refrigeration system.

The disclosed technology also provides a method of operating a refrigeration system, where the refrigeration system utilizes a low GWP refrigerant. The described method includes the step of: (I) supplying to the refrigeration system a working fluid that includes (a) a lubricating oil component comprising (i) a polyolester oil, wherein the polyolester oil comprises dipentaerythritol esterified with a mixture of carboxylic acids, wherein the mixture of carboxylic acids comprise at least one linear carboxylic acid having 8 to 10 carbon atoms and (ii) alkylbenzene, and (b) a low GWP refrigerant, wherein the low GWP refrigerant comprises hydrofluoroolefin-1336mzzZ/trans-1,2-dichloroethylene. In some embodiments, the working fluid may be free of or substantially free of C5 carboxylic acids, such as linear carboxylic acids. Any of the working fluids or components of working fluids described herein may be used in the described methods of operating any of the described refrigeration systems.

The present methods, systems and compositions are thus adaptable for use in connection with a wide variety of heat transfer systems in general and refrigeration systems in particular, such as air-conditioning (including both stationary and mobile air conditioning systems), refrigeration, heat-pump systems, and the like. In certain embodiments, the compositions of the present invention are used in refrigeration systems originally designed for use with an HFC refrigerant, such as, for example, R-410A or R-404A.

As used herein, the term “refrigeration system” refers generally to any system or apparatus, or any part or portion of such a system or apparatus, which employs a refrigerant to provide cooling and/or heating. Such refrigeration systems include, for example, air conditioners, electric refrigerators, chillers, heat pumps, and the like.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

The invention may be better understood with reference to the following non-limiting examples.

### EXAMPLES

A series of ester lubricants are prepared, suitable for use in working fluids that contain low GWP refrigerants.

| | | | | | Dilution | |
|---|---|---|---|---|---|---|
| | Poly- | Poly- | | | 0.743 | Misci- |
| | olester | olester | Alkyl- | Polyalpha | Bar and | bility |
| Ex | 1¹ | 2² | benzene | Olefin | 32° C.³ | at 10%⁴ |
| 1 | 82 | | 18 | | 24.4% | −20° C. |
| 2 | | 79 | 21 | | >50% | −25° C. |
| 3 | 100 | | | | >50% | −20° C. |
| 4 | 70 | | 30 | | Not Run | −15° C. |
| 5 | 50 | | 50 | | Not Run | −10° C. |
| 6 | 81 | | | 19 | Not Run | −5° C. |
| 7 | | 77 | | 23 | Not Run | −5° C. |

¹Polyolester 1 comprises 14% Dipentaerythritol, 5% linear C7 carboxylic acid, 17% C8 linear C8 carboxylic acid, 53% branched C9 carboxylic acid, and 11% linear C10 carboxylic acid.
²Polyolester 2 comprises 14.3% Dipentaerythritol, 15.4% linear C5 carboxylic acid, 3.4% linear C7 carboxylic acid, 66.9%, and 66.9% branched C9 carboxylic acid.
³Wt % of refrigerant solubilized in the POE/Alkyl benzene fluid. Dilution is measured by charging a known amount of refrigerant and lubricant in a Parr pressure vessel equipped with a pressure gauge, at low temperature and letting the vessel equilibrate to the desired temperature. Measurement of pressure at a given temperature allows calculation of the amount of refrigerant solubilized in lubricant from difference in refrigerant contained in vapor phase.
⁴Lowest temperature at which the refrigerant/lubricant composition is one phase at 10% refrigerant concentration in Lubricant. Miscibility is measured by placing a known amount of lubricant and refrigerant by wt % in a glass tube, sealing to maintain constant refrigerant gas mass with the lubricant and observing the phase behavior at different temperature increments. Miscibility tubes are heated and/or cooled over a range of temperatures and phase change is monitored. Phases will be recorded as one of the following: One Phase (OP or IP) - Lubricant and refrigerant are in one phase; Hazy (H or Hz) - Lubricant/Refrigerant is still one phase, but solution appears iridescent, or translucent. Cloudy (C or Cl) - Lubricant/Refrigerant mixture appears thick, white, or milky, but no distinct phase separation is visible. Two Phase (TP or 2P) - Lubricant and Refrigerant can be clearly distinguished as two separate phases. First observed temperature with Hazy or two = phase reading is recorded as the first immiscible temperature.

The working fluid of Example 1 above, shows superior performance in terms of dilution and miscibility with the low GWP refrigerant having a dilution of less than 25% and a miscibility temperature of −20 ° C. or lower.

Each of the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

What is claimed is:

1. A working fluid for a low global warming potential refrigeration system comprising a compressor comprising:
(a) a lubricating oil component comprising (i) a polyolester oil, wherein the polyolester oil comprises dipentaerythritol esterified with a mixture of carboxylic acids, wherein the mixture of carboxylic acids comprises at least one linear carboxylic acid having 8 to 10 carbon atoms and (ii) an alkylbenzene; and
(b) a refrigerant comprising hydrofluoroolefin-1336mzzZ/trans-1,2-dichloroethylene.

2. The working fluid of claim 1, wherein the polyolester oil has a neat viscosity of 150 cSt to 180 cSt measured at 40° C. according to ASTM D445.

3. The working fluid of claim 1, wherein the alkylbenzene has a neat viscosity of 3 cSt to 100 cSt measured at 100° C. according to ASTM D445.

4. The working fluid of claim 1, wherein the polyolester oil comprises 10 mol % to 20 mol % of a linear carboxylic acid having 8 carbon atoms.

5. The working fluid of claim 1, wherein the polyolester oil comprises 5 mol % to 12 mol % of a linear carboxylic acid having 10 carbon atoms.

6. The working fluid of claim 1, wherein the polyolester oil comprises 10 mol % to 20 mol % dipentareythritol, 0 mol % to 10 mol % of a linear carboxylic acid having 5 carbon atoms, 3 mol % by weight to 10 mol % of a linear carboxylic acid having 7 carbon atoms, 10 mol % to 20 mol % of a linear carboxylic acid having 8 carbon atoms, 40 mol % to 70 mol % of a branched carboxylic acid having 9 carbon atoms, and 5 mol % to 12 mol % of a linear carboxylic acid having 10 carbon atoms.

7. The working fluid of claim 1, wherein the lubricating oil component comprises:
(a) 75% by weight to 95% by weight polyolester oil; and
(b) 5% by weight to 25% by weight alkylbenzene.

8. A refrigeration system, comprising a compressor and a working fluid, wherein the working fluid comprises:
a lubricating oil component comprising (i) 80 mol % to 90 mol % of a polyolester oil, wherein the polyolester oil comprises 10 mol % to 20 mol % dipentareythritol, 0 mol % to 10 mol % of a linear carboxylic acid having 5 carbon atoms, 3 mol % to 10 mol % of a linear carboxylic acid having 7 carbon atoms, 10 mol % to 20 mol % of a linear carboxylic acid having 8 carbon atoms, 40 mol % to 70 mol % of a branched carboxylic acid having 9 carbon atoms, and 5 mol % to 12mol % of a linear carboxylic acid having 10 carbon atoms, and (ii) 10% by weight to 20% by weight of an alkylbenzene.

9. The refrigeration system of claim 8, wherein the polyolester oil comprises 12 mol % to 18 mol % dipentareythritol, 0 mol % to 3 mol % of a linear carboxylic acid having 5 carbon atoms, 3 mol % to 7 mol % of a linear carboxylic acid having 7 carbon atoms, 12 mol % to 18 mol % of a linear carboxylic acid having 8 carbon atoms, 50 mol % to 60 mol % of a branched carboxylic acid having 9 carbon atoms, and 8 mol % to 12 mol % of a linear carboxylic acid having 10 carbon atoms.

10. A method of lubricating a compressor comprising supplying to the compressor a working fluid comprising:
(a) a lubricating oil component comprising (i) a polyolester oil, wherein the polyolester oil comprises dipentaerythritol esterified with a mixture of carboxylic acids, wherein the mixture of carboxylic acids comprises at least one linear carboxylic acid having 8 to 10 carbon atoms and (ii) an alkylbenzene; and
(b) a refrigerant comprising hydrofluroolefin-1336mzzZ/trans-1,2-dichloroethylene.

11. The method of claim 10, wherein the polyolester oil has a neat viscosity of 150 cSt to 180 cSt measured at 40° C. according to ASTM D445.

12. The method of claim 10, wherein the alkylbenzene has a neat viscosity of 3 cSt to 100 cSt measured at 100° C. according to ASTM D445.

13. The method of claim 10, wherein the polyolester oil comprises 10 mol % to 20 mol % of a linear carboxylic acid having 8 carbon atoms.

14. The method of claim 10, wherein the polyolester oil comprises 5 mol % to 12 mol % of a linear carboxylic acid having 10 carbon atoms.

15. The method of any of claim 10, wherein the polyolester oil comprises 10 mol % to 20 mol % dipentareythritol, 0 mol % to 10 mol % of a linear carboxylic acid having 5 carbon atoms, 3 mol % by weight to 10 mol % of a linear carboxylic acid having 7 carbon atoms, 10 mol % to 20 mol % of a linear carboxylic acid having 8 carbon atoms, 40 mol % to 70 mol % of a branched carboxylic acid having 9 carbon atoms, and 5 mol % to 12 mol % of a linear carboxylic acid having 10 carbon atoms.

16. The method of claim 10, wherein the lubricating oil component comprises:
(a) 75% by weight to 95% by weight polyolester oil; and
(b) 5% by weight to 25% by weight alkylbenzene.

17. The method of claim 10, wherein the lubricating oil component comprises:
(a) 80% by weight to 90% by weight polyolester oil; and
(b) 10% by weight to 20% by weight alkylbenzene.
